(19) United States
(12) Patent Application Publication
(10) Pub. No.: US 2015/0260348 A1
(43) Pub. Date: Sep. 17, 2015

(54) System and Method for Inhibiting Hydrate Film Growth On Tubular Walls

(71) Applicants: Larry D. Talley, Friendswood, TX (US); Jason W. Lachance, Magnolia, TX (US)

(72) Inventors: Larry D. Talley, Friendswood, TX (US); Jason W. Lachance, Magnolia, TX (US)

(21) Appl. No.: 14/602,987

(22) Filed: Jan. 22, 2015

Related U.S. Application Data
(60) Provisional application No. 61/951,758, filed on Mar. 12, 2014.

(51) Int. Cl. F17D 1/17; F16L 58/00

(52) U.S. Cl. CPC F17D 1/17; F16L 58/00

(57) ABSTRACT

Methods and systems are provided for inhibiting the formation and/or growth of clathrate hydrates in a mixed phase fluid at or near the walls of a tubular through use of a chemical or physical coating on the tubular wall. An exemplary embodiment provides a method for producing a flowable mixed phase fluid having the potential to create clathrate hydrates. The method includes inhibiting hydrate formation in a tubular by injecting an additive into a fluid stream in the tubular, and the additive adheres, at least in part, to the walls of the tubular and inhibits hydrate growth proximate to the wall. When sufficient additive is injected into the tubular system, the hydrate film growth on the tubular walls is inhibited, at least to some extent, and a continuous flow rate is maintained.

### CROSS REFERENCE TO RELATED APPLICATIONS

This application claims the priority benefit of U.S. patent application No. 61/951,758 filed Mar. 12, 2014 entitled SYSTEM AND METHOD FOR INHIBITING HYDRATE FILM GROWTH ON TUBULAR WALLS, the entirety of which is incorporated by reference herein.

### FIELD

Exemplary embodiments of the present techniques relate to maintaining the flowability of a mixed phase fluid in a tubular. More specifically, compounds that can adhere to the tubular walls and inhibit hydrate film growth are injected into the mixed phase fluid.

### BACKGROUND

The presence of water in production fluids may cause problems while transporting a hydrocarbon due to the formation of clathrate hydrates with the hydrocarbons. Clathrate hydrates (commonly called hydrates) are weak composites formed from a water matrix and a guest molecule, such as methane or carbon dioxide, among others. Hydrates may form, for example, at the high pressures and low temperatures that may be found in pipelines and other hydrocarbon equipment. After forming, the hydrates can agglomerate, leading to plugging or fouling of the equipment. Various techniques have been used to lower the ability for hydrates to form or cause plugging or fouling. Those techniques include insulation of lines, dehydration of the hydrocarbon, and the adding of hydrate inhibitors, such as thermodynamic hydrate inhibitors (THIs), and low dosage hydrate inhibitors (LDHIs).

There are two major classes of low dosage hydrate inhibitors (LDHIs) commercially available: kinetic hydrate inhibitors (KHIs) and anti-agglomerants (AAs). Kinetic hydrate inhibitors slow the formation of hydrates, but not by changing the thermodynamic conditions. Instead, KHIs inhibit the nucleation and growth of the hydrate crystals. Such materials may include, for example, Poly(2-alkyl-2-oxazoline) polymers (or poly(N-acylalkylene imine) polymers), poly(2-alkyl-2-oxazoline) copolymers, and others. See Urdahl, Olav, et al., “Experimental testing and evaluation of a kinetic gas hydrate inhibitor in different fluid systems,” Preprints from the Spring 1997 Meeting of the ACS Division of Fuel Chemistry, 42, 498-502 (American Chemical Society, 1997).

KHIs are known to prevent hydrate formation in flowlines operating in continuous flow mode with temperatures and pressures that are continuously in the hydrate-stability phase envelope. The hydrate-stability phase envelope includes the region on a temperature versus pressure diagram wherein hydrates may form because temperatures are sufficiently low, or pressures are sufficiently high, or both. When an effective level of kinetic hydrate inhibitors is in use, the flowline is generally free of hydrates both on the tubular wall as well as in the bulk flowing fluids. However, should the level be slightly low, allowing a hydrate film to form on the wall of a tubular, the hydrate film along the wall can seed hydrate formation in the bulk flowing fluid. Further, when a hydrate film forms on the wall of a tubular, that film of hydrates can seed hydrate formation in the bulk flowing fluid even when the bulk flowing fluid is treated with kinetic hydrate inhibitor.

U.S. Pat. No. 6,359,047 discloses a gas hydrate inhibitor. The inhibitor includes, by weight, a copolymer including about 80 to about 95% of polyvinyl caprolactam (VCL) and about 5 to about 20% of N,N-dialkylaminoethyl(meth)acrylate or N-(3-dimethylaminopropyl) methacrylamide.

As another example, U.S. Pat. No. 5,874,660 discloses a method for inhibiting hydrate formation. The method can be used in treating a petroleum fluid stream such as natural gas conveyed in a pipe to inhibit the formation of a hydrate restriction in the pipe. The hydrate inhibitor used for practicing the method is selected from the family of substantially water soluble copolymers formed from N-methyl-N-vinylacetamide (VIMA) and one of three comonomers, vinylpyrrolidone (VP), vinylpiperidone (VPip), or vinylcaprolactam (VCap). VIMA/VCap is the preferred copolymer. These copolymers may be used alone or in combination with each other or other hydrate inhibitors. Preferably, a solvent, such as water, brine, alcohol, or mixtures thereof, is used to produce an inhibitor solution or mixture to facilitate treatment of the petroleum fluid stream.

In contrast to KHIs, anti-agglomerants (AAs) allow hydrates to form, but the hydrates formed in the bulk liquid are generally limited in size and do not adhere to pipe walls or to each other. Many AA molecules are incorporated into the initial hydrate seed particle. A hydrophilic head group on each AA molecule is held by hydrogen bonding to the hydrate particle. The lipophilic or hydrophobic side chain that is part of the active AA is not enclathrated by the hydrate particle, generally. This side chain helps reduce the tendency of the hydrates to adhere to one another and impede flow. Besides hydrate formation in the bulk liquid, water film that forms on the tubular wall can form hydrates. Some AAs slow hydrate film growth on tubular walls, but however fail to altogether prevent hydrate film growth.

AAs are developed in bench-scale testing that specifically target performance of an additive based on the hydrate particle size measured in the bulk phase, or on other fluid properties, such as viscosity. The supplier often uses typical fluids in the bench-scale test that are representative of the fluids expected in field applications. Generally the testing is carried out in an apparatus that forms hydrates in a batch reactor mode and rarely if ever in a once-through test resembling a field operation. Sometimes the testing is done with actual field fluids. However, testing in a batch bench-scale test is not as effective at mirroring a crucial component of the field application, namely, hydrate film growth on the pipe wall.

In most commercial processes, the growth of hydrates on the tubular wall is too slow to be observed in a batch test. It can only be observed in a continuous process over time. Thus, even when batch testing has been used to qualify an AA for use in a continuous process in a field application, the field will eventually have problems with hydrate blockages, which must subsequently be remediated.

Surface active agents (surfactants) may function both as KHIs and as anti-agglomeration agents. For example, U.S. Pat. Nos. 5,841,010 and 6,015,929 disclose the use of surface active agents as gas hydrate inhibitors for inhibiting the formation (nucleation, growth and agglomeration) of clathrate hydrates. The methods include adding into a mixture including hydrate forming substituents and water, an effective amount of a hydrate inhibitor selected from the group consisting of anionic, cationic, non-ionic and zwitterionic hydrate inhibitors. The hydrate inhibitor has a polar head group and a nonpolar tail group not exceeding 12 carbon atoms in the longest carbon chain. The anti-agglomeration agents may allow for the formation of a flowable slurry, i.e., hydrates that can be carried by a flowing fluid (hydrocarbon stream) without sticking to each other.

Related information may be found in U.S. Pat. Nos. 6,957,146; 5,936,040; 5,841,010; and 5,744,665. Further information may be found in: U.S. Patent Application Publication Nos. 2004/0133531, 2006/0092766, 2008/0312478 and 2007/0129256; Sloan, E. D., “Gas Hydrate Tutorial,” Preprints from the Spring 1997 Meeting of the ACS Division of Fuel Chemistry, 42(2), 449-56 (American Chemical Society, 1997); and in Talley, L. D. and Edwards, M., “First Low Dosage Hydrate Inhibitor is Field Proven in Deepwater,” Pipeline and Gas Journal 44, 226 (1999). Additional references include Pan, et al., “Superomniphobic Surfaces for Effective Chemical Shielding,” J. Am. Chem. Soc. 2013, 135, 578-581; as well as Kelland, “History of the Development of Low Dosage Hydrate Inhibitors,” Energy & Fuels—ENERG FUEL 03/2006; 20(3). DOI:10.1021/ef050427x.

The techniques discussed above may help to prevent or inhibit to some extent the formation of hydrates or the plugging of lines by hydrates. However, the hydrate inhibitors described above may not prevent hydrate blockages, since formation of hydrate films along the walls of a tubular may lead to flow problems over time.

### SUMMARY

An exemplary embodiment provides a system for inhibiting the formation of hydrate particles. The system incorporates flowing a mixed phase fluid having a potential for hydrate formation through a tubular. Also included is an injector configured to inject an additive into the mixed phase fluid, and the additive inhibits the formation of hydrate crystals proximate to the walls of the tubular.

Another exemplary embodiment provides a method for decreasing hydrate formation in a tubular system. The method includes injecting an additive into a fluid stream in the tubular system, and the additive adheres, at least in part, to the wall of the tubular. The additive can be selected based off of the efficacy of how it inhibits hydrate growth proximate to the wall.

Another exemplary embodiment provides a method for decreasing hydrate formation on the wall of a tubular. The method includes injecting a first additive into a mixed phase fluid stream, and injecting a second additive into the mixed phase fluid stream. One or the other or both of these additives can be injected into a tubular system to decrease hydrate formation proximate to the walls of the tubular. The method also includes separating additives from the original fluid stream containing hydrates, water, and other products, and storing or disposing of certain products.

### DESCRIPTION OF THE DRAWINGS

The advantages of the present techniques are better understood by referring to the following detailed description and the attached drawings, in which:

FIG. 1 is a diagram of a subsea natural gas field that can be protected from hydrate plugging;

FIG. 2 is a diagram illustrating the inside of a tubular containing a mixed phase fluid that is capable of producing hydrates, the hydrates shown aggregating as a film on the wall of the tubular;

FIG. 3 is a diagram illustrating fouling that typically occurs on tubular walls in systems capable of producing hydrates;

FIG. 4 is a diagram illustrating how in a mixed phase fluid hydrate particles may form on a film of water proximate to the walls of a tubular system;

FIG. 5 is a diagram illustrating how the cross-sectional area of the tubular decreases as hydrate film growth occurs;

FIG. 6 is a graph showing how the concentration of hydrate in the mixed phase fluid and the flow rate are inversely related;

FIG. 7 is a process flow diagram of a method for producing a fluid with potential for hydrate formation that maintains a continuous rate of flow using an additive;

FIG. 8 is a process flow diagram of a method for producing a fluid with potential for hydrate formation that maintains a continuous rate of flow using an additive;

FIGS. 9A, 9B and 9C illustrate a process flow diagram of a method that maintains a continuous rate of flow through use of an additive, an analyzer and an addition system;

FIG. 10 is a graph of the hydrate equilibrium curve for methane, in accordance with an exemplary embodiment of the present techniques;

FIG. 11 is a diagram of a cold-flow reactor that is connected to or within the tubular, that utilizes multiple static mixers in series to manipulate fluid flow by synthesizing smaller, less viscous, and more flowable “dry” hydrate particles;

FIG. 12 is a diagram illustrating typical static mixers, with a colder ambient fluid being introduced counterflow to that of the mixed phase fluid with the potential for hydrate formation; and

FIG. 13 is a diagram of a typical surface pipeline used for transporting fluids.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, “clathrate” or “clathrate hydrate” is a weak composite made of a host compound that forms a basic framework and a guest compound that is held in the host framework by inter-molecular interaction, such as hydrogen bonding, Van der Waals forces, and the like. Clathrates may also be called host-guest complexes, inclusion compounds, and adducts. As used herein, “clathrate hydrate” and “hydrate” are interchangeable terms used to indicate a clathrate having a basic framework made from water as the host compound. A hydrate is a crystalline solid which looks like ice, and forms when water molecules form a cage-like structure around a “hydrate-forming constituent.”

A “hydrate-forming constituent” refers to a compound or molecule in petroleum fluids, including natural gas, which forms a hydrate at elevated pressures, reduced temperatures, or both. Illustrative hydrate-forming constituents include, but are not limited to, hydrocarbons such as methane, ethane, propane, butane, neopentane, ethylene, propylene, isobutylene, cyclopropane, cyclobutane, cyclopentane, cyclohexane, and benzene, among others. Hydrate-forming constituents can also include non-hydrocarbons, such as oxygen, nitrogen, hydrogen sulfide, carbon dioxide, sulfur dioxide, and chlorine, among others.

“Exemplary” is used exclusively herein to mean “serving as an example, instance, or illustration.” Any embodiment described herein as “exemplary” is not to be construed as preferred or advantageous over other embodiments.

A “tubular” is not restricted to flow spaces with a cylindrical shape (i.e., with a generally circular axial cross-section), but is instead intended to encompass enclosed flow spaces of any desired cross-sectional shape, such as rectangular, oval, annular, non-symmetrical, etc. In addition, the term “tube” also contemplates enclosed flow spaces whose cross-sectional shape or size varies along the length of the tube.

A “mixed phase fluid” as used herein is a fluid containing constituents at two or more phases of matter. For example, a liquid-solid mixed phase fluid contains liquid matter and solid particulate matter flowing within the liquid. Two immiscible liquids may form so-called liquid-liquid mixed phase fluids. A gas and liquid dispersion is a gas-liquid mixed phase fluid containing a liquid and dispersed gas bubbles within the flowable fluid mixture.

A “facility” as used herein is a representation of a tangible piece of physical equipment through which hydrocarbon fluids are either produced from a reservoir or injected into a reservoir. In its broadest sense, the term facility is applied to any equipment that may be present along the flow path between a reservoir and the destination for a hydrocarbon product. Facilities may include production wells, injection wells, well tubulars, wellhead equipment, gathering lines, manifolds, pumps, compressors, separators, surface flow lines and delivery outlets. In some instances, the term “surface facility” is used to distinguish those facilities other than wells. A “facility network” is the complete collection of facilities that are present in the model, which would include all wells and the surface facilities between the wellheads and the delivery outlets.

The term “FSO” refers to a Floating Storage and Offloading vessel. A floating storage device, usually for oil, is commonly used where it is not possible or efficient to lay a pipe-line to the shore. A production platform can transfer hydrocarbons to the FSO where they can be stored until a tanker arrives and connects to the FSO to offload it. A FSO may include a liquefied natural gas (LNG) production platform or any other floating facility designed to process and store a hydrocarbon prior to shipping.

A “formation” is any finite subsurface region. The formation may contain one or more hydrocarbon-containing layers, one or more non-hydrocarbon containing layers, an overburden, and/or an underburden of any subsurface geologic formation. An “overburden” and/or an “underburden” is geological material above or below the formation of interest.

The term “gas” is used interchangeably with “vapor,” and means a substance or mixture of substances in the gaseous state as distinguished from the liquid or solid state. Likewise, the term “liquid” means a substance or mixture of substances in the liquid state as distinguished from the gas or solid state. As used herein, “fluid” is a generic term that may include either a gas or vapor.

A “hydrocarbon” is an organic compound that primarily includes the elements hydrogen and carbon although nitrogen, sulfur, oxygen, metals, or any number of other elements may be present in small amounts. As used herein, hydrocarbons generally refer to organic materials that are transported by pipeline, such as any form of natural gas or oil. A “hydrocarbon stream” is a stream enriched in hydrocarbons by the removal of other materials such as water and/or any additive.

The term “cold flow” refers to a process that utilizes mostly mechanical means, e.g., static mixers, to achieve low viscosity hydrate slurry formation. The cold flow hydrate slurry may be analytically indistinguishable from the anti-agglomerant hydrate slurry, but its formation process is distinguishable.

The term “natural gas” refers to a multi-component gas obtained from a crude oil well (associated gas) or from a subterranean gas-bearing formation (non-associated gas). The composition and pressure of natural gas can vary significantly. A typical natural gas stream contains methane (C₁) as a significant component. Raw natural gas will also typically contain ethane (C₂), higher molecular weight hydrocarbons, one or more acid gases (such as carbon dioxide, hydrogen sulfide, carbonyl sulfide, carbon disulfide, and mercaptans), and minor amounts of contaminants such as water, nitrogen, iron sulfide, wax, and crude oil.

“Pressure” is the force exerted per unit area by the gas on the walls of the volume. Pressure can be shown as pounds per square inch (psi). “Atmospheric pressure” refers to the local pressure of the air. “Absolute pressure” (psia) refers to the sum of the atmospheric pressure (14.7 psia at standard conditions) plus the gauge pressure (psig). “Gauge pressure” (psig) refers to the pressure measured by a gauge, which indicates only the pressure exceeding the local atmospheric pressure (i.e., a gauge pressure of 0 psig corresponds to an absolute pressure of 14.7 psia). The term “vapor pressure” has the usual thermodynamic meaning. For a pure component in an enclosed system at a given pressure, the component vapor pressure is essentially equal to the total pressure in the system.

“Production fluid” refers to a liquid and/or gaseous stream removed from a subsurface formation, such as an organic-rich rock formation. Produced fluids may include both hydrocarbon fluids and non-hydrocarbon fluids. For example, production fluids may include, but are not limited to, oil, natural gas and water.

“Substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context.

“Well” or “wellbore” refers to a hole in the subsurface made by drilling or insertion of a conduit into the subsurface. The terms are interchangeable when referring to an opening in the formation. A well may have a substantially circular cross section, or other cross-sectional shapes (for example, circles, ovals, squares, rectangles, triangles, slits, or other regular or irregular shapes). Wells may be cased, cased and cemented, or open-hole well, and may be any type, including, but not limited to a producing well, an experimental well, an exploratory well, or the like. A well may be vertical, horizontal, or any angle between vertical and horizontal (a deviated well), for example a vertical well may include a non-vertical component.

### Overview

As discussed herein, the formation of hydrates can be a problem in the harvesting and transportation of hydrocarbons. For example, production fluids harvested from a formation may contain a substantial amount of water, which may increase over time as the hydrocarbons in the formation are produced. This addition of water into the system may also increase the rate of hydrate growth.

Typical lab tests used for declaring a certain hydrate inhibitor to be effective include a loop, autoclave, or rocking cell test, to name a few, that determine whether the hydrates formed in the test are flowable. Some tests also include an observation of hydrate adhesion tendency. However, where the quantity of adhesion observed is low or unobservable, the test may fail to indicate that in an actual field application, with fluids passing only once through the pipeline, even a very small fraction of adhesion of hydrates (such as less than 0.1%) may result in a blockage of the pipeline. Numerous classes of molecules of different compositions of matter have been shown to inhibit corrosion in oil and wet gas systems. Many of these also interfere with hydrate inhibition in the bulk water phase.

An exemplary embodiment of the present techniques provides a method for decreasing the formation of hydrate films along the walls of a tubular, such as a pipe or a well, among others. This can be performed by introducing an additive into the system which adheres to the walls of the tubular and inhibits, at least in part, hydrate film growth on the walls of the tubular, thus maintaining continuous flow within the system. The additive compound may also be a corrosion inhibitor, or other chemical designed to protect the wall of the tubular from damage. The present techniques can provide systems and methods for inhibiting hydrate film growth on tubular walls in cold-flow processes as well as anti-agglomerant processes. It is known that a key limitation of cold-flow processes is the hydrate film growth that occurs on the walls of a tubular is independent of the hydrate slurry formation in the bulk liquid phase.

Another exemplary embodiment of the present techniques include introducing monomers or oligomers of a kinetic hydrate inhibitor to maintain flow rates inside tubular systems for extended periods and without the need for remediation. Such KHI monomers or oligomers may be selected as an additive based, at least in part, on adhesive properties with the tubular walls, and effectiveness at inhibiting hydrate film growth proximate to the tubular walls. Using sufficient monomers or oligomers as film growth inhibitors, whether or not coupled with an appropriate hydrate-slurry formation process, flowlines can operate either indefinitely or for significantly prolonged periods of time without hydrate blockage or differential pressure buildup requiring remediation.

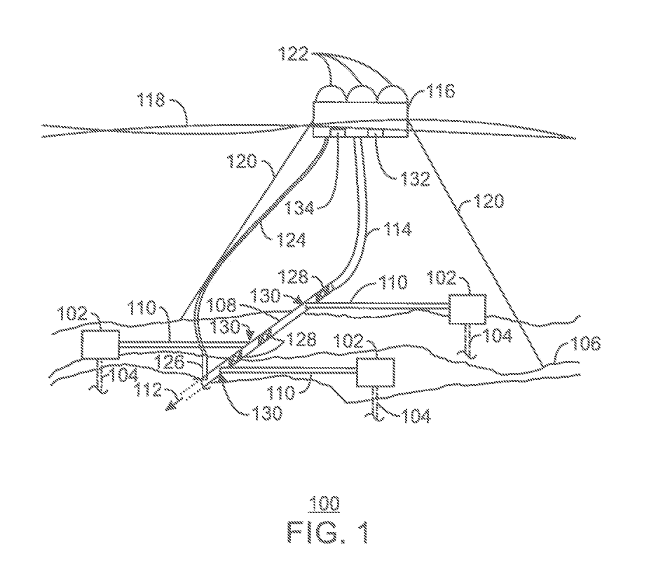

FIG. 1 is an illustration of a subsea natural gas field 100 that can be protected from hydrate plugging. However, the present techniques are not limited to subsea fields or natural gas harvesting, but may be used for the mitigation of plugging in the production or transportation of oil, oil from oil sands, natural gas, any number of liquid or gaseous hydrocarbons from any number of sources, or any number of mixed phase fluids from any number of sources having the potential to form clathrate hydrates.

As shown in FIG. 1, the natural gas field 100 can have a number of wellheads 102 coupled to wells 104 that harvest natural gas from a formation (not shown). As shown in this example, the wellheads 102 may be located on the ocean floor 106. Each of the wells 104 may include single wellbores or multiple, branch wellbores. Each of the wellheads 102 can be can be coupled to a central pipeline 108 by gathering lines 110. The central pipeline 108 may continue through the field 100, coupling to further wellheads 102, as indicated by reference number 112.

A flexible line 114 may couple the central pipeline 108 to a collection platform 116 at the ocean surface 118. The collection platform 116 may, for example, be a floating processing station, such as a floating storage and offloading unit (or FSO), that is anchored to the sea floor 106 by a number of tethers 120. The collection platform 116 may have equipment for dehydration, purification, and other processing, such as liquefaction equipment to form purified hydrocarbons for storage in vessels 122. The collection platform 116 may transport the processed gas to shore facilities by pipeline (not shown).

Prior to processing of the hydrocarbons on the collection platform 116, the collected gas may cool and form hydrates in various locations, such as the collection pipeline 108, the gathering lines 110, or the flexible line 114, among others. The formation of the hydrates may lead to partial or even complete plugging of the lines 108, 110, and 114. Similarly, in on-shore fields, hydrates can plug wells, gathering lines, and collection lines. An additive may be added to mitigate the formation of hydrates, for example, from the collection platform 116 by a line 124 to one or more injection points, such as at injector 126. Although the line 124 is shown as being independent of the flexible line 114, the line 124 may be incorporated along with the flexible line 114 and any other utility or sensor lines into a single piping bundle. In various embodiments, the injector 126 may be located on the collection pipeline 108, the gathering lines 110, the flexible line 114, or on any combinations thereof.

An additive can be injected into the collection line 108 in an amount that is less than required to completely inhibit the formation of hydrates. Even though monomers or oligomers of kinetic hydrate inhibitor may not stop formation of hydrates in the bulk fluid, the monomers or oligomers may be effective at stopping hydrate film growth on tubular walls. A tubular includes any means for transporting a fluid containing hydrates, and can be, for example, a pipeline or a similar flow line for flowing a fluid. The line 114 can be considered a tubular. The ability to stop hydrate film growth can be tested in a once-through apparatus that can detect hydrate formation on the wall of the test flow apparatus. The test apparatus can allow hydrate formation to occur in the bulk liquid phase. The determination of the efficacy of the additive can be made by the amount of hydrate film, if any, that forms on the wall of the flow apparatus. An effective film prevention additive does not allow buildup of hydrate on the wall of the flow apparatus. In such instances, the inside diameter of the flow apparatus does not decrease with time due to hydrate film growth. When the hydrate film growth is prevented, hydrate slurries can flow for a prolonged period of time without blockage of the flow.

The additive injected 126 into the collection line 108 may be controlled so that the hydrates form only as a monolayer on the walls of the tubular, wherein further hydrate film growth is passivated and no significant fouling of the flowline occurs. With such additives as film growth inhibitors, flowlines may operate for significantly prolonged periods of time without hydrate blockage.

Further, the additive use may be coupled with an appropriate hydrate slurry process, such as cold-flow technology to lower the likelihood of hydrate blockages forming. For example, one or more static mixers 128 can be placed in the lines, for example, in the collection line 108 downstream of the entry points 130 for each of the gathering lines 110. The placement of the static mixers 128 is not limited to the collection line 108, as static mixers 128 may be placed in the flexible line 114, the gathering lines 110, the wellheads 102, or even down the wells 104.

Injecting a growth inhibitor down a well, for example, upstream of a static mixer 128, may be useful for mitigating hydrate formation in wellbores.

The rate of flow and composition of the production fluid brought up the flexible line 114 from the connection pipe 108 may be monitored, for example, by an analyzer 132 at any number of points in the natural gas field 100. The analyzer 132 may determine the concentration of the hydrate and size of hydrate particles, the concentration of any additives, the amount of hydrocarbon present, or any combinations of these parameters. For example, a particle size analyzer may be included to analyze the different refracting items in the production fluid, such as the hydrate particles and the hydrocarbon droplets. The output from the analyzer 132 may be used to control an addition system 134, which may be used to adjust the amount of additive, or additives, sent to the injector 126. In an exemplary embodiment, the configuration discussed above may be used to maintain flow rate by controlling the amount of additive injected in order to sufficiently inhibit hydrate film growth at the tubular walls. The arrangement of the facility network is not limited to that shown in FIG. 1, as any number of configurations may be used.

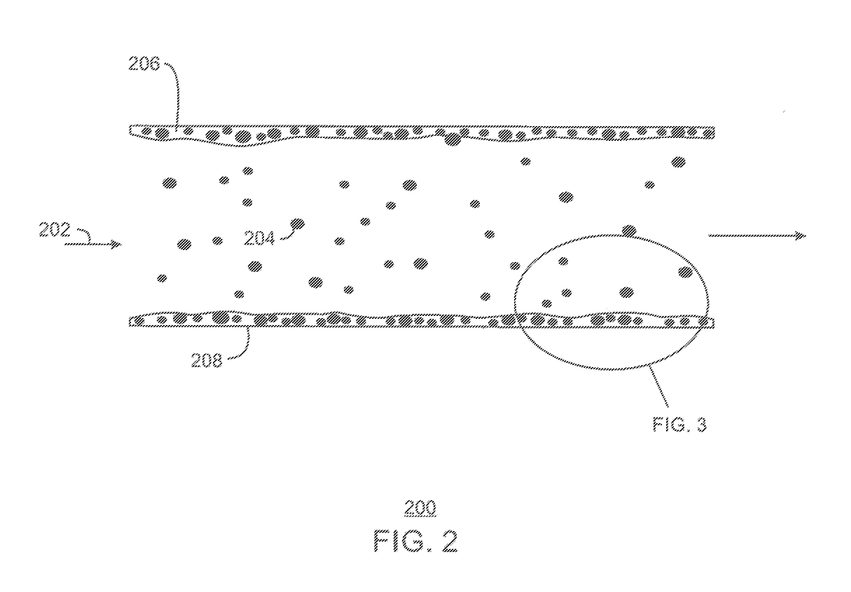

FIG. 2 illustrates the inside of a tubular 200 containing a mixed phase fluid 202 that is capable of producing hydrates 204. The hydrates 204 are shown aggregating together and may also form a film 206 on the inner wall 208 of the tubular. In an exemplary embodiment, an additive is injected into the tubular system 200 that adheres to the tubular walls 208 and helps to inhibit, at least in part, hydrate film growth 206. Sufficient inhibition of hydrate film growth 206 can help to prevent plugging of the flowline. This may allow mixed phase fluid 202 to flow continuously and the tubular system 200 to operate primarily at steady state, for example, with mostly laminar flow.

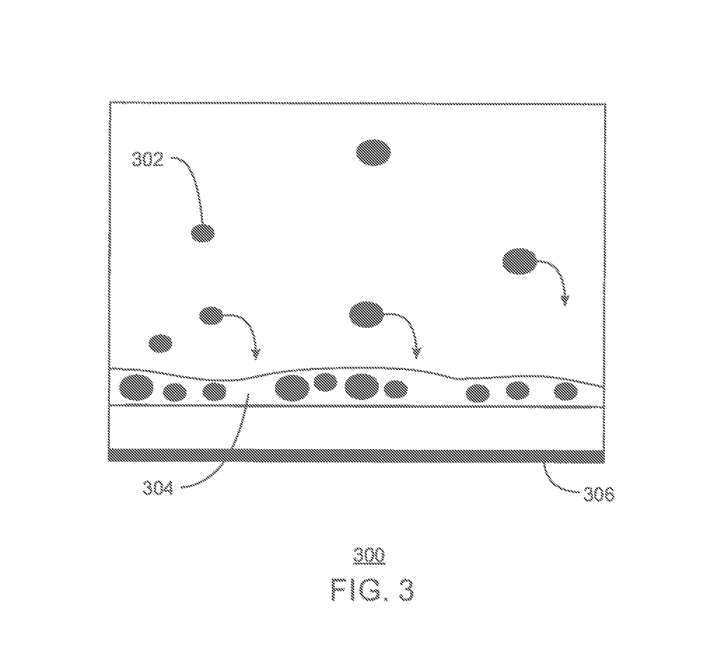

FIG. 3 illustrates a magnified view of hydrate fouling 304 that typically occurs on tubular walls 306. In systems 300 that are untreated, and which have a mixed phase fluid capable of producing hydrates 302, hydrate particles may form and lead to fouling 304 the system 300. When system parameters of sufficiently high pressure and low temperature have been established, the system 300 is placed within the phase envelope where hydrate formation 302 becomes an issue.

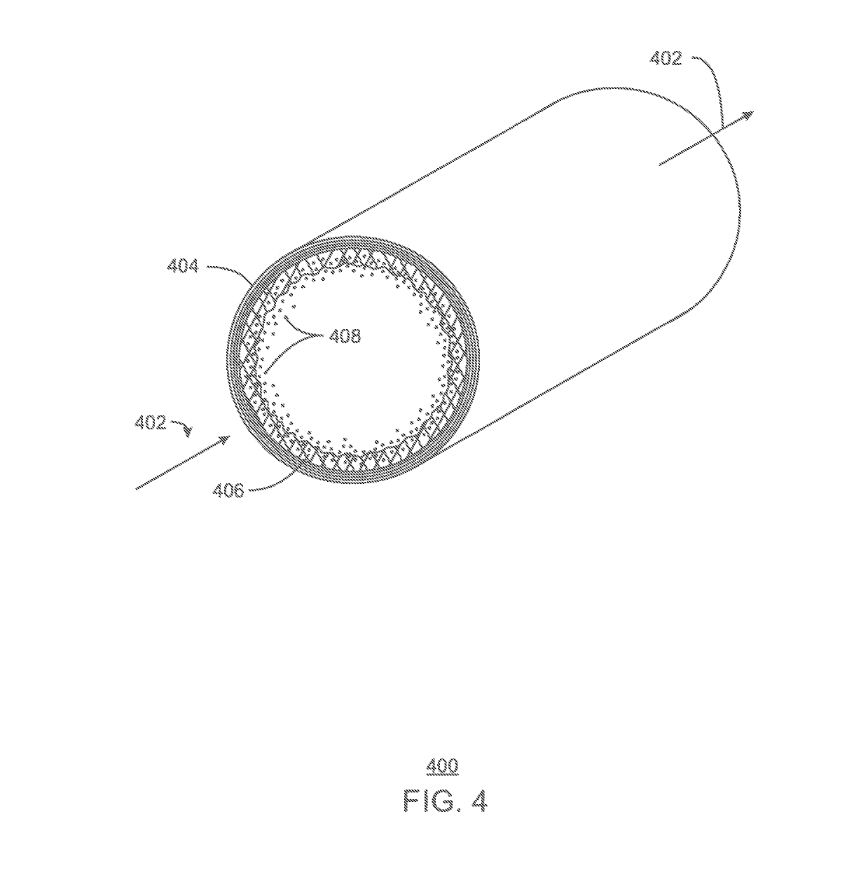

FIG. 4 is a diagram illustrating how in a mixed phase fluid 402 hydrate particles 408 may form on a film of water 406 proximate to the inner walls 404 of a tubular system 400. According to an exemplary embodiment of the current techniques, conversion of the water film 406 on a tubular wall 404 to hydrates 408 is inhibited by processes described herein. Namely, an additive can be used that inhibits, at least to some extent, the synthesis of hydrates 408 in the thin film of water 406. When too many hydrates 408 are formed in the film of water 406, fouling of the tubular system 400 may result, and can lead to costly remedial measures. The composition of the inner wall of tubular systems 400 can be chosen from a range of materials that are hydrophobic or otherwise repel water films. In another embodiment, the tubular system 400 can be coated with a material chosen from a wide range of materials that are hydrophobic or repel water films.

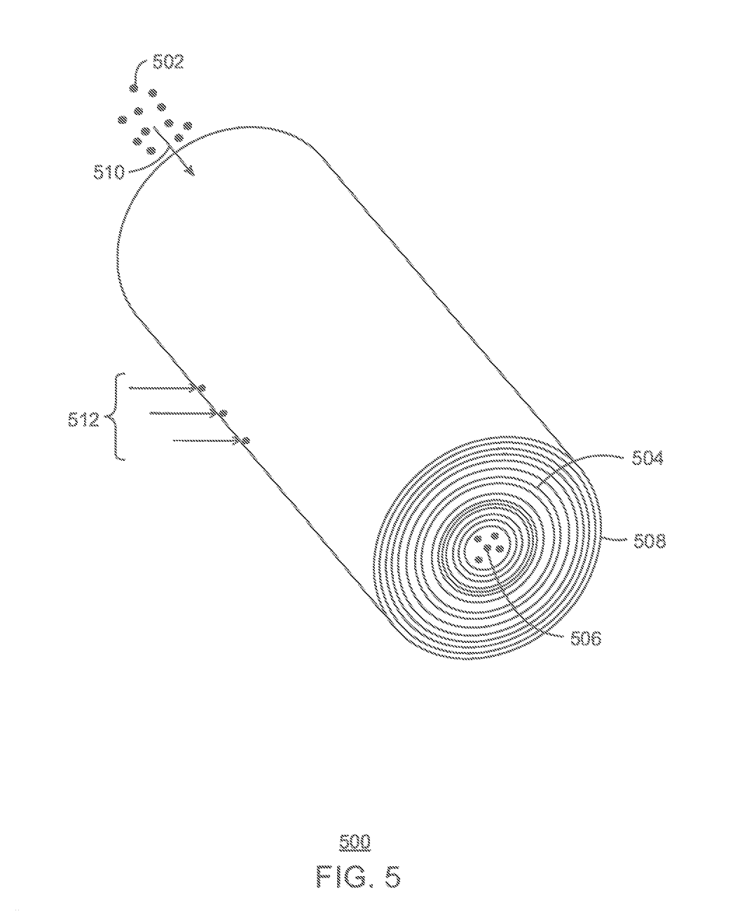

FIG. 5 is a diagram illustrating how the inner cross-sectional area of the tubular 500 decreases over time. As hydrate film growth creates layers of fouling 504 on the inner wall 508, these layers continue to grow and build upon one other as water continues to form a film on the hydrate film on the walls. Hydrate particles 502 produced in the mixed phase fluid may begin to aggregate and form larger, more viscous hydrate particles 502 as time in the system increases. As the untreated system is in operation, film growth 504 on the inner wall 508 optionally combined with adhesion of hydrate particles formed in the bulk liquid to the hydrate film on the wall decreases the effective diameter of the tubular 500, and may, ultimately, plug the open region 506 within the tubular 500.

An exemplary embodiment of the present techniques provides a method for generating a flowable mixed phase fluid 510 having the potential for hydrate formation at certain temperatures and pressures. This can be performed preferably by introducing an additive at, for example, injection points 512 into the system which adheres to the walls of the tubular 508, or to the water film on the tubular walls, or to the hydrate layer formed from the water film on the tubular walls, resisting at least in part, hydrate film growth 504 on the walls of the tubular 508, thus maintaining continuous flow within the system 506. The additive may, concurrently, inhibit corrosion of the walls of the tubular 508. The additive may repel water films or lower attractive forces between hydrate solids and the walls such that the hydrates are sufficiently inhibited from adhering to the tubular walls. The amount of additive to be injected can be determined by analyzing or monitoring concentration, particle size and flow rate.

One example of an additive that may inhibit hydrate film growth is a quaternary amine designed to adhere to a tubular wall in a similar manner to a corrosion inhibitor. The effectiveness of a particular additive may be enhanced by additional functionalization of the quaternary amine moiety. Another additive that may be used to inhibit film growth is an imidazoline designed to adhere to a pipe wall as do corrosion inhibitors. The effectiveness of a particular imidazoline may be enhanced by additional functionalization of the molecule containing the imidazoline group. The effectiveness of an additive containing a given functional group, such as a quaternary amine or an imidazoline, may be enhanced by incorporating more than one quaternary amine or imidazoline functional group into the same molecule.

Further examples of film growth inhibitors include a sulfonic acid. It may be designed to adhere to a pipe wall but be oil soluble or water soluble as needed for a particular application. The effectiveness of a sulfonic acid additive may be enhanced by additional derivatization. Another example of an additive may be a phosphate or phosphonate, such as an anti-wear or anti-friction additive, designed to adhere to a metal wall. The effectiveness of a phosphate or phosphonate additive may be enhanced by additional derivatization. Additionally, an example of an inhibitor is a xanthate designed to adhere to a metal wall, such as an anti-wear additive. The effectiveness of a xanthate may be enhanced by additional derivatization. Furthermore, an amide additive, such as the monomers used in kinetic hydrate inhibitors, is an example of a hydrate film growth inhibitor. When these amide monomers are designed to adhere to the wall of a tubular, they sufficiently inhibit film growth but do not inhibit hydrate formation in the bulk liquid phase. Finally, an example of an effective hydrate film growth inhibitor is a lactam, such as caprolactam, used in kinetic hydrate inhibitors. The effectiveness of an amide or a lactam may be enhanced by additional derivatization that makes the additive adhere more strongly to the wall of the tubular.

Examples of effective hydrate film growth inhibitors based on kinetic hydrate inhibitor chemistry are provided. They may include, and are not limited to: pyrrolidone; caprolactam; isopropylmethacrylamide; any oxazoline or cyclic iminoethers; any amino acid; any diethanolamides, dioctylsulfosuccinates, sorbitans, ethoxylated alcohols, ethoxylated fatty acids, and ethoxylated amines. Effective film growth inhibitors based on kinetic hydrate inhibitor chemistry also include: any acrylamide; any lactam; any amide; any combination of amide monomers; any succinimide; any maleimide; any imide; any amine oxide; any N-oxide; any betaine; any peptide; any antifreeze protein; and any substituted urea monomer. Effective additives may be included of any derivative of the above examples such that the average molecular weight remains below about 500 daltons, and any oligomer of the above examples such that the average molecular weight remains below about 500 daltons.

The list of effective inhibitors is compiled based on chemical structures that are known to have the property of surface activity deriving from the functional groups cited. Additionally, each structure listed is known to have hydrate inhibition activity when used in the form of polymers. Each film growth inhibitor example listed includes any substituted or derivatized material based on the named structure since those derived materials will generally retain surface activity similar to the parent material.

In addition to the hydrate film growth inhibitors discussed above, corrosion inhibitors may also function as inhibitors of hydrate films. Such inhibitors may include, for example, any imidazoline; any quaternary amine; any combination of the above; any derivative of the above; any oligomer of the above examples such that the average molecular weight remains below about 500 daltons. Some corrosion inhibitors may be more effective than others at inhibiting film growth. The effectiveness of certain corrosion inhibitors may be enhanced by increasing the strength of the adhesion of the inhibitor to a pipe wall. Thus, structures that work better as batch corrosion inhibitors than as continuous dose corrosion inhibitors may be more effective as film growth inhibitors.

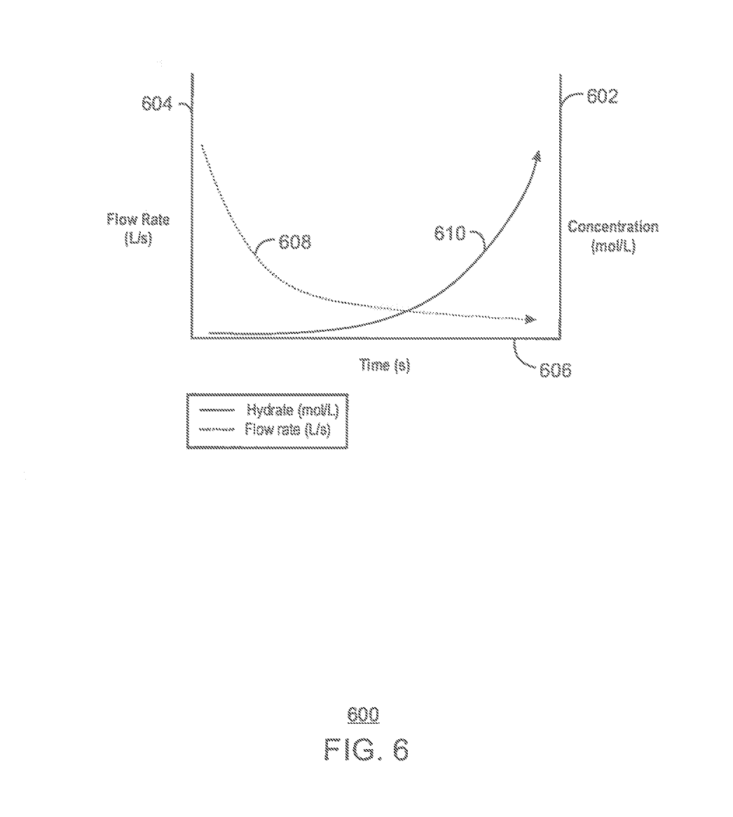

FIG. 6 is a graph 600 showing how the concentration of hydrate 602 in the mixed phase fluid and the flow rate 604 of the mixed phase fluid may be inversely related. The curves 608, 610 are speculative, are meant to conceptualize the effect of hydrate formation on system flow rate, and may show how this dynamic changes with time. As time 606 increases, the concentration of hydrate 602 in the system may also increase, aggregating and adhering to the hydrate film layers on the tubular wall, while causing the flow rate 604 of the mixed phase fluid to decrease significantly. Curve 608 indicates how initial flow rate within the tubular system is relatively high, and this flow rate decreases over time as more hydrate particles are formed and agglomerate with one another. Curve 610 indicates how initial concentration of hydrate particles in the system is relatively low, and this concentration increases over time as more hydrate particles are formed and agglomerate, which may contribute to decreasing flow or plugging within the tubular.

Experiments have been conducted with chemical additives with efficiencies of the order of about 90% hydrate film growth inhibition. In other words, the hydrate film layer took at least about ten times longer to grow the same amount as seen without any inhibitor additive. It has also been found that by using available additives as a film growth inhibitor, the hydrate film thickness was about 10% of the thickness as compared to the hydrate film thickness in a system without the additive. Span 80 is a proprietary chemical tested in a cold flow field trial that was effective at inhibiting hydrate film growth. Its efficiency was about 90% by both measures (decreasing the time it took for the hydrate film to grow by about 90%, and decreasing the physical thickness of the hydrate film by about 90%). Champion Assure HI-43-DW is a commercial anti-agglomerant that was also around 90% effective at inhibiting hydrate growth, in both time required for the hydrate concentration to increase, and mass (film thickness) efficiency. In addition to being more effective at hydrate growth inhibition, the use of additives in exemplary embodiments are also more economical than conventional techniques for inhibiting hydrate formation and growth.

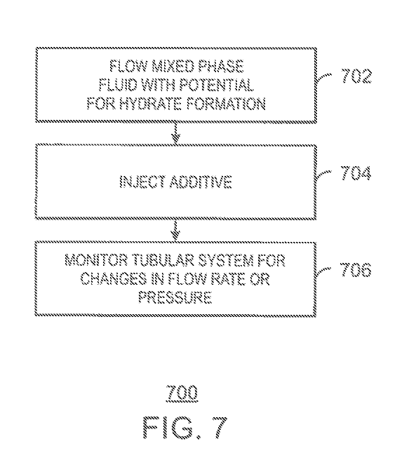

FIG. 7 is a process flow diagram of a method for maintaining a flow rate of a fluid in a tubular. The method 700 begins at block 702 when a mixed phase fluid is flowed through a tubular. At block 704, an additive is injected into the tubular. As described herein, the additive can be selected to adhere to the walls of the tubular and inhibit the formation of hydrate films. At block 706, changes in flow rate and pressure within the tubular system will be monitored. The additive introduced at block 704, in accordance with embodiments discussed herein, may be in the form of an anti-corrosion agent, a film growth inhibiting monomer or oligomer, or both, or another hydrate film growth inhibitor. The additive may be selected in order to both sufficiently adhere to tubular walls and successfully inhibit hydrate film growth.

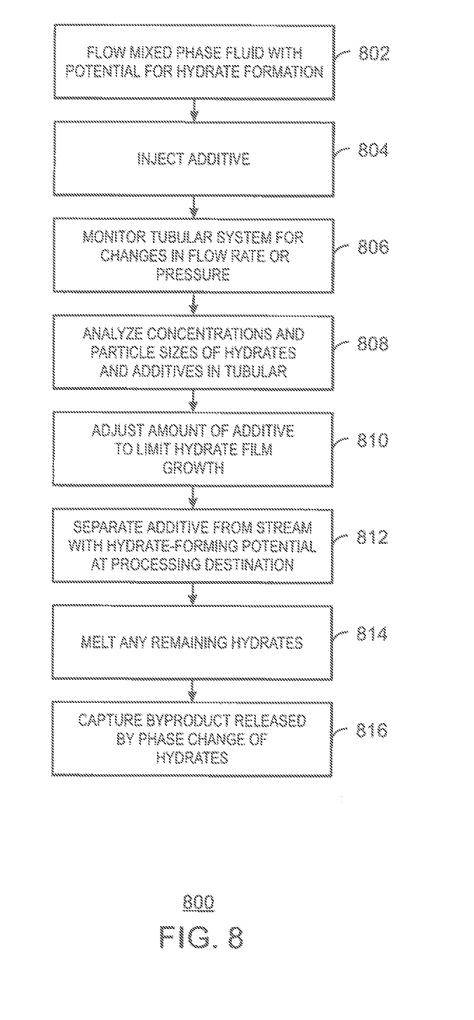

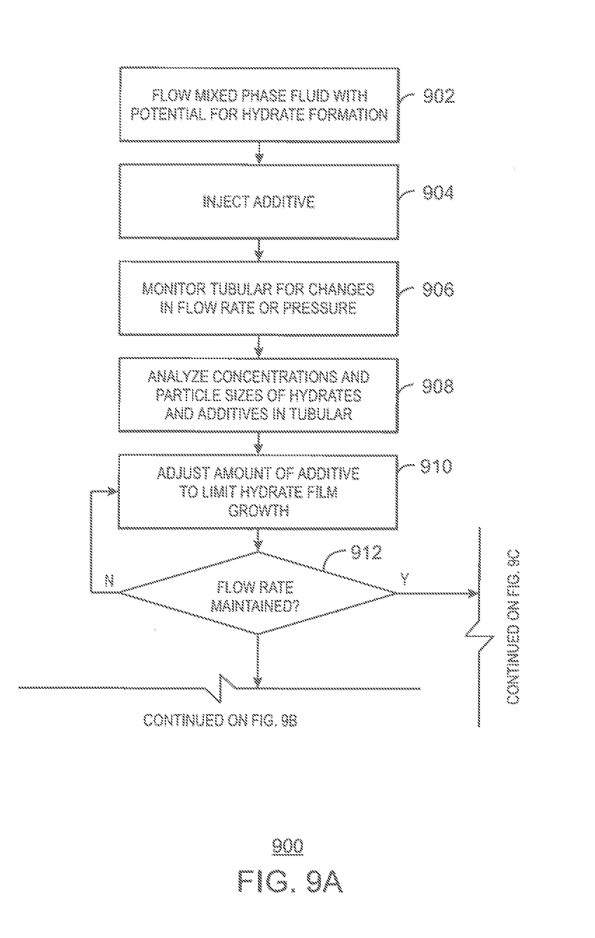

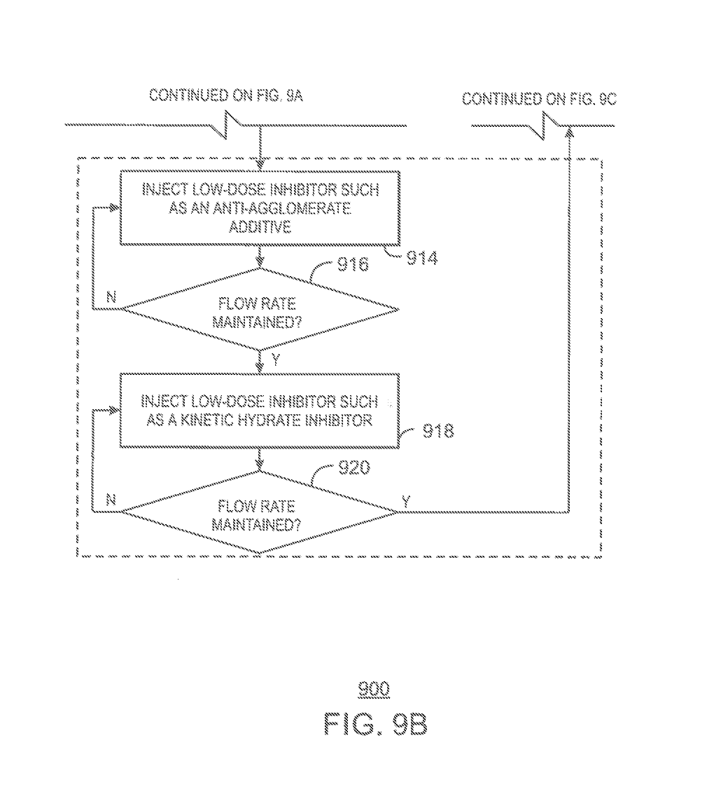

FIG. 8 is a process flow diagram of a method for maintaining a flow rate of a fluid in a tubular. The method 800 begins at block 802 when a mixed phase fluid is flowed through a tubular. At block 804, an additive is injected into the tubular. The mixed phase fluid is monitored at block 806 to detect changes in flow rate or pressure. The mixed phase fluid is analyzed at block 808 to determine concentrations and particle sizes within the mixed phase fluid. At block 810, concentration of additive is adjusted accordingly to inhibit hydrate nucleation and film growth at the tubular walls. This may help maintain a continuous rate of flow of the mixed phase fluid within the tubular, allowing the mixed phase fluid to be further transported to processing facilities and the like. At such facilities, the additive can then be separated at block 812 from the mixed phase fluid. The remaining hydrates can be melted at block 814. At block 816, the byproducts of the phase change can be captured and stored.

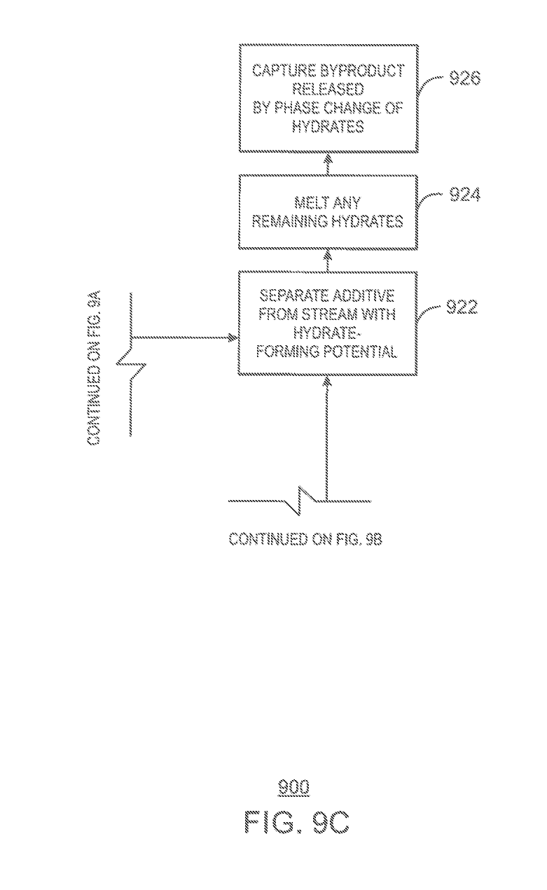

FIGS. 9A, 9B and 9C illustrate a process flow diagram of a method for maintaining a flow rate of a fluid in a tubular. The method 900 begins in FIG. 9A at block 902 when a mixed phase fluid is flowed through a tubular. At block 904, an additive is injected into the tubular. The mixed phase fluid is monitored at block 906 to detect changes in flow rate or pressure. The mixed phase fluid is analyzed at block 908 to determine concentrations and particle sizes within the mixed phase fluid. At block 910, concentration of additive is adjusted accordingly to inhibit hydrate nucleation and film growth at the tubular walls. If flow rate within the tubular has been sufficiently maintained at decision block 912, then the fluid within the tubular continues to its next destination and separation procedures at block 922 in FIG. 9C can proceed. If the flow rate has not been sufficiently maintained at block 912, then the amount of hydrate introduced into the tubular system is again adjusted and the determination of whether sufficient flow rate has been maintained is made again.

The processes in FIG. 9B inside the dotted lines can additionally be incorporated into the current method. If flow rate is not being sufficiently maintained, then like with adjusting the concentration of additive at block 910, other additives may be injected and subsequently adjusted. An anti-agglomerant may be injected at block 914. The determination of whether flow rate is sufficiently maintained happens at decision node 916, and the process will either continue to block 918 or the amount of AA can be adjusted again at 914 until flow rate is maintained. The same process can also apply to injecting a KHI at block 918. The determination of whether flow rate is sufficiently maintained again occurs at a decision node 920, and the process will either continue to block 922 in FIG. 9C or the amount of KHI can be adjusted until flow rate is maintained. As shown in FIG. 9B, both an anti-agglomerant and a KHI may be injected. However, either an AA or KHI may be used alone.

When flow is steady and continuous within the tubular system, the mixed phase fluid can more easily be transported to downstream processing facilities and the like. In FIG. 9C, at block 922 any additive can be separated from the stream with hydrate-forming potential at a processing destination. At block 924, remaining hydrates can be further melted. At block 926, the byproduct released through the phase change of the hydrates can be captured and stored.

### Examples

The techniques discussed above can be used in any number of systems, for example, subsea pipelines, surface pipelines, pipelines utilized at chemical processing and refining facilities, etc. Additional examples of how cold flow technology may be utilized as a subset of an application are now presented. Cold flow systems are exemplary of processes which can incorporate the current method and system, and are in no way meant to limit the scope of the invention to use merely in cold flow processes. An example of the current invention used with the cold flow process is described in Talley, et al. “Method of Generating a non-plugging hydrate slurry,” WO 2007/095399. The current invention is equally useful with the cold flow process described by Lund, et al. “Method and system for transporting a flow of fluid hydrocarbons containing water,” British patent no. GB 2,358,640, Norwegian patent no. NO 311.854.

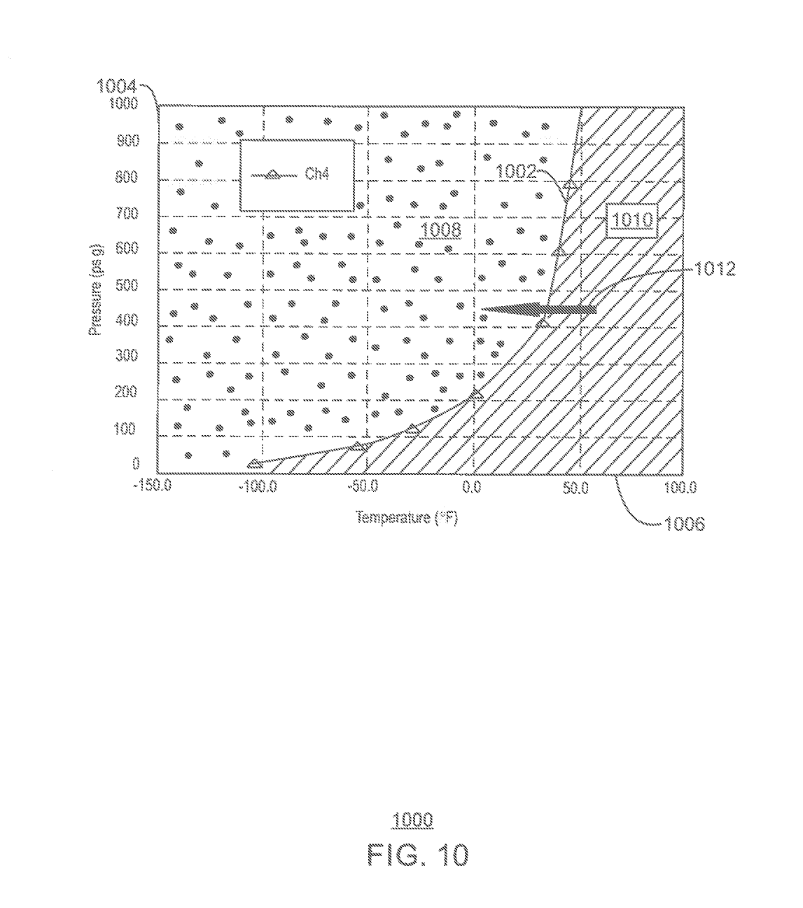

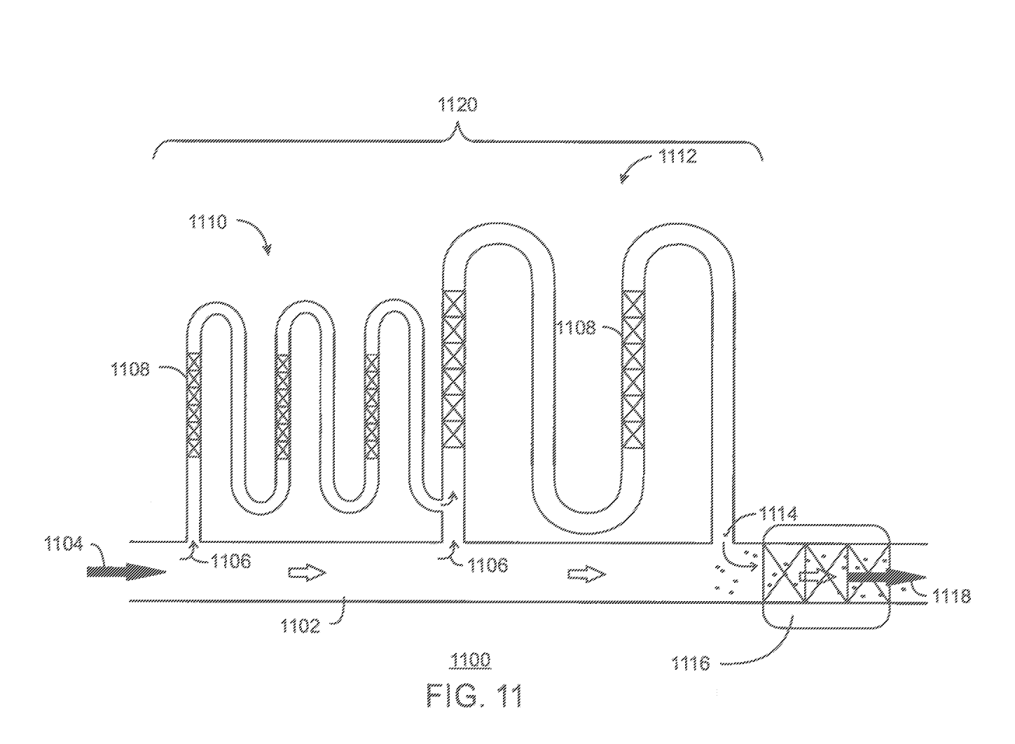

FIG. 10 is a graph 1000 of the hydrate equilibrium curve for methane 1002 in accordance with an exemplary embodiment of the present techniques. In the graph 1000, the x-axis 1006 represents the temperature of a system in degrees Fahrenheit, while the y-axis 1004 represents the pressure of the system in pounds per square inch, gauge (psig). The equilibrium curve 1002 indicates the pressure and temperature at which the hydrate is in equilibrium with the individual components, i.e., water and methane gas. In a first region 1008, generally at higher pressure and lower temperatures, formation of the hydrate crystals may occur. In a second region 1010, generally at lower pressures and higher temperatures, the decomposition of the hydrates of all components may occur. Arrow 1012 is meant to indicate how a rapid drop in temperature (and increase in pressure to a lesser extent) can drive the mixed phase fluid into the region 1008 in which hydrates form. This can be deliberately performed to cause the formation of a hydrate slurry that remains flowable, as discussed with respect to FIG. 11.

FIG. 11 is a diagram of a cold-flow reactor system 1100 that is connected to a tubular 1102 with mixed phase fluid stream 1104 flowing within. The stream 1104 splits off at selected points 1106 into staged sections of static mixers 1108. Smaller static mixers 1108 and larger static mixers 1108 in series comprise the side cold-flow reactor 1120. The staged design 1110, 1112 of the cold-flow reactor 1120 also helps to ensure the hydrate particles remain small enough so that subsequent formation of larger and larger hydrates, which agglomerate and plug flow more easily, is avoided. The static mixers 1108 help the mixed phase fluid achieve maximum mass transfer and heat transfer for efficient dry hydrate formation. These techniques are used in an exemplary embodiment to manipulate fluid flow and synthesize smaller, “dry” hydrate particles 1114 that are more conducive to maintaining continuous flow. The mixed phase fluid will have an increased concentration of these smaller hydrate particles 1114 after leaving the cold-flow reactor 1120. An optional static mixer 1116 can be utilized downstream of the cold-flow reactor 1120. Stream 1118 is the mixed phase fluid after passing through the cold-flow reactor 1120 and the final, optional in-line static mixer 1116.

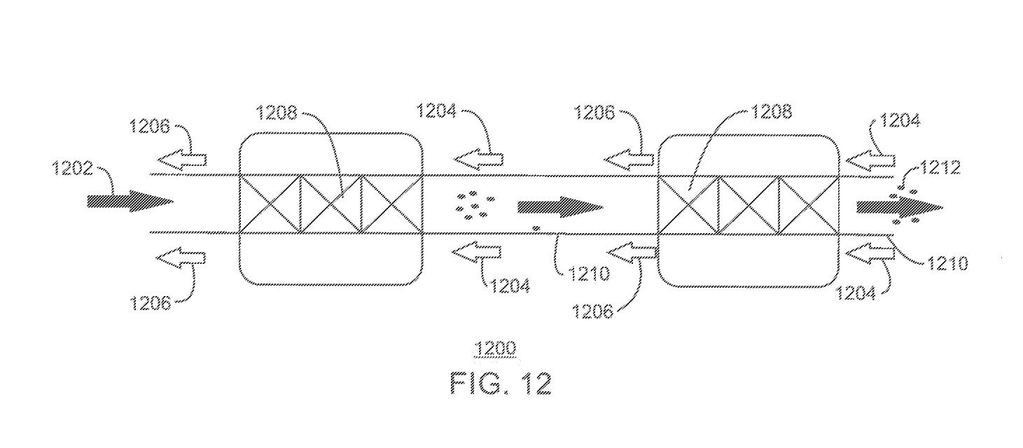

FIG. 12 is a diagram illustrating an in-line static mixer system 1200 with counterflow heat exchangers. A mixed phase fluid with the potential for hydrate formation 1202 is flowed through a tubular in one direction. Colder ambient liquid is being introduced counterflow 1204 to that of the mixed phase fluid with the potential for hydrate formation 1202. The ambient liquid has a lower temperature compared to the mixed phase fluid. The ambient liquid at arrow 1204 is colder than at arrow 1206 because the ambient liquid at 1206 absorbs heat transferred from the mixed phase fluid 1202, thus decreasing the temperature of the mixed phase fluid 1202. Static mixers 1208, which are used according to embodiments of the present invention, serve to disperse the water and the gas in the mixed phase fluid into smaller water and gas droplets that are converted into dry hydrate particles. As used herein, “dry hydrate particles” are small hydrate particles with a relatively low surface area that are less likely to form larger “sticky” hydrate particles, which easily agglomerate and hinder flow within the tubular. Droplet diameter is known to depend on the droplet and continuous phase viscosity, shear rate (or fluid velocity), and interfacial tension between the droplet and continuous phase. In a static mixer, the water droplet diameter is decreased because shear rate is increased. Water droplet surface area is maximized by maximizing the fluid flow rate through the static mixer section, or, in other words, by increasing the Reynolds number.

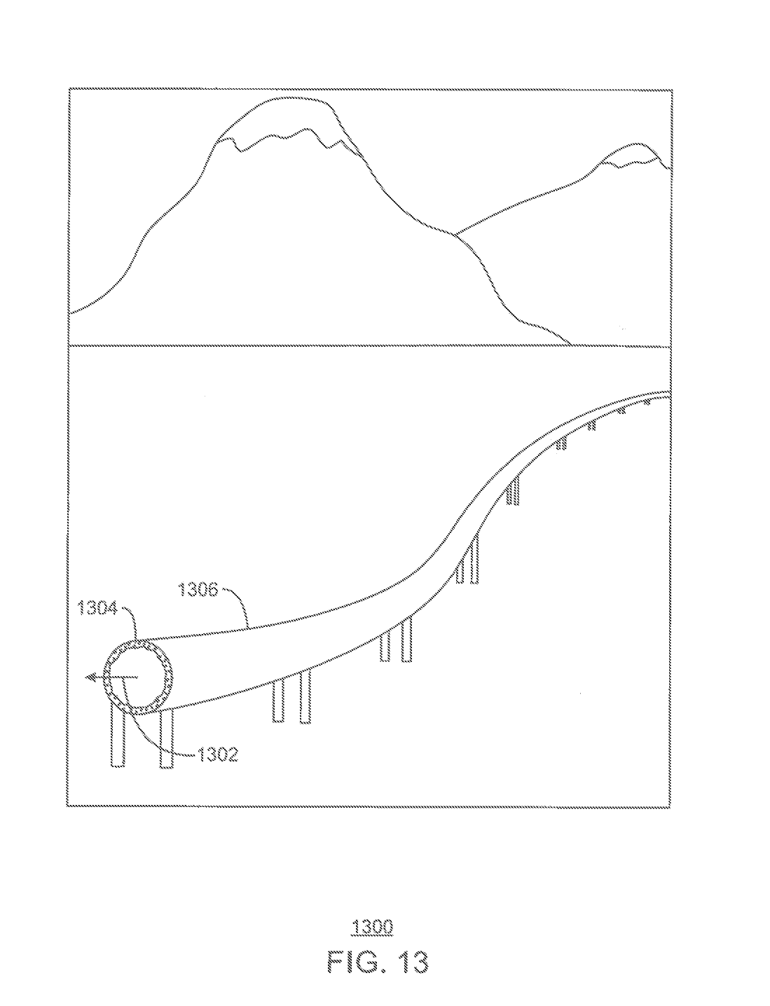

An exemplary embodiment utilizes both the additive to adhere to tubular walls 1210 and sufficiently inhibit hydrate film growth, as well as cold flow technology using static mixers to maintain flowability within the tubular system. The static mixers 1208 help ensure production of a dry hydrate slurry composed of hydrate particles 1212 that are more amenable to flow in the bulk liquid phase and less likely to plug. Thus, in an exemplary embodiment, the additive ensures hydrate film growth at the wall of the tubular 1210 is inhibited, e.g., that the wall of the tubular 1210 is passivated, while the static mixers 1208 affect the formation of hydrates in the bulk fluid, and make hydrate particles that are less likely to agglomerate and impede volumetric flow within the tubular. The addition of the additives to inhibit growth of hydrate films at the wall of the tubular is not limited to subsea applications. The additives may, instead, be used in any number of other applications in which hydrates may pose a problem, for example, as discussed with respect to FIG. 13.

FIG. 13 is a diagram of a typical surface pipeline 1300 for the transportation of hydrocarbons and other fluid streams over long distances. In pipelines 1300 that are untreated, and which have a mixed phase fluid capable of producing hydrates 1302, hydrate particles may form and lead to fouling 1304 at the inner walls of the pipeline 1306. When system parameters of sufficiently high pressure and low temperature have been established, the mixed phase fluid 1302 in the pipeline 1300 is placed within the phase envelope where hydrate formation becomes an issue. The techniques described herein can be implemented in pipelines 1300 such as these, helping to ensure a continuous rate of flow is maintained within them.

While the present techniques may be susceptible to various modifications and alternative forms, the exemplary embodiments discussed above have been shown only by way of example. For example, the use of the term “about” means ±10% of the subsequent number, unless otherwise stated, and embodiments including such variance are within the scope of this disclosure. However, it should again be understood that the techniques are not intended to be limited to the particular embodiments disclosed herein. Indeed, the present techniques include all alternatives, modifications, and equivalents falling within the true spirit and scope of the appended claims.

What is claimed is:

1. A system for producing a mixed phase fluid, including:
a tubular configured to carry a mixed phase fluid; and
an injector configured to inject an additive into the mixed phase fluid, wherein the additive inhibits the formation of hydrates proximate to the walls of the tubular.

2. The system of claim 1, wherein the additive further acts as an anti-corrosion agent.

3. The system of claim 1, wherein the additive is a kinetic hydrate inhibitor (KHI).

4. The system of claim 1, wherein the anti-corrosion agent acts as a kinetic hydrate inhibitor (KHI).

5. The system of claim 1, wherein the additive is a monomer of a hydrate film growth inhibitor.

6. The system of claim 5, wherein the monomer exhibits adhesive properties with the walls of the tubular.

7. The system of claim 1, wherein the composition of the tubular is primarily corrosion resistant alloy.

8. The system of claim 1, wherein the composition of the tubular has hydrophobic properties.

9. The system of claim 1, wherein the tubular has a coating having hydrophobic properties.

10. The system of claim 1, wherein the additive includes a lactam, a lactone, an amide, an imide, an oxide monomer, an amino acid, a peptide, an antifreeze protein, an oxazoline, a cyclic iminoether, a sorbitan, an ethoxylated alcohol, or any derivative or combination thereof.

11. The system of claim 10, further including an oligomer or polymer with an average molecular weight below about 500 daltons.

12. The system of claim 1, wherein the additive includes an imidazoline, a quaternary amine, or any combination or derivative thereof.

13. The system of claim 12, further including an oligomer or polymer with an average molecular weight below about 500 daltons.

14. The system of claim 1, further including a static mixer or series of static mixers for passing the mixed phase fluid through downstream of the injector.

15. The system of claim 1, wherein the mixed phase fluid is composed partially of natural gas.

16. The system of claim 1, wherein the mixed phase fluid is composed partially of oil.

17. A method for decreasing hydrate formation in a tubular, including injecting an additive into a fluid stream in the tubular, wherein the additive adheres, at least in part, to the wall of the tubular and inhibits hydrate growth proximate to the wall.

18. The method of claim 17, wherein the additive is selected based, at least in part, on adhesive properties of the additive to the tubular wall.

19. The method of claim 17, wherein the additive is further selected based, at least in part, on the efficacy of the additive to inhibit hydrate film growth.

20. The method of claim 17, wherein the amount of additive decreases over time as the tubular wall becomes sufficiently coated with the additive, and as hydrate formation proximate to the walls of the tubular decreases.

21. The method of claim 17, further including determining variance in flow rate and changes in pressure over time.

22. The method of claim 17, further including changing the amount of the additive agent in order to maintain and control steady production rate.

23. The method of claim 17, further including removing additive from the fluid stream.

24. The method of claim 17, further including producing the fluid stream from a hydrocarbon field.

25. A method for decreasing hydrate formation on the wall of a tubular, including:
injecting a first additive into a mixed phase fluid stream;
injecting a second additive into the mixed phase fluid stream to decrease hydrate formation proximate to the walls of the tubular; and
separating additives from the original fluid stream containing hydrates, water, and other products.

26. The method of claim 25, wherein the first additive is chosen to decrease corrosion of the walls of the tubular.

27. The method of claim 25, wherein the first additive is an anti-agglomerant.

28. The method of claim 25, further including using a static mixer or series of static mixers in the tubular downstream from the site of additive injection.

29. The method of claim 28, further including determining variance in flow rate and changes in pressure over time.

30. The method of claim 25, wherein the first additive, the second additive, or both is selected based, at least in part, on adhesive properties to the tubular wall.

31. The method of claim 25, wherein the first additive, the second additive, or both is selected based, at least in part, on the efficacy of the additive to inhibit hydrate film growth.

32. The method of claim 25, further including determining concentrations of the mixed phase fluid, hydrate particle size, variance in flow rate and changes in pressure overtime.

33. The method of claim 25, further including changing the amount of the additive agent in order to maintain and control steady production rate.

34. The method of claim 25, including removing the first additive, the second additive, or both from the mixed phase fluid.

35. The method of claim 25, including producing the mixed phase fluid from a hydrocarbon field.
